(19) United States
(12) Patent Application Publication
(10) Pub. No.: US 2019/0360826 A1
(43) Pub. Date: Nov. 28, 2019

(54) CONTEXT BASED RIDE OFFER SEARCH

(71) Applicant: INTERNATIONAL BUSINESS MACHINES CORPORATION, ARMONK, NY (US)

(72) Inventors: Satoshi Hosokawa, Kodaira (JP); Yasutaka Nishimura, Yamato (JP); Asuka Unno, Tokyo (JP); Shoichiro Watanabe, Tokyo (JP)

(21) Appl. No.: 15/988,013

(22) Filed: May 24, 2018

(51) Int. Cl. G01C 21/34; G06Q 10/02; G06Q 50/30; G01C 21/36

(52) U.S. Cl. CPC G01C 21/3438; G06Q 10/02; G01C 21/362; G01C 21/3446; G01C 21/3611; G06Q 50/30

(57) ABSTRACT

A method for searching for a ride offer that includes receiving a plurality of ride offers that specify a route that a vehicle passes along. The method further receives location information of an origin and a destination for a passenger, and a preference of the passenger for at least one of a get-on point and a get-off point. The method further determines an origin candidate point that satisfies the preference for the get-on point, and determines an origin route being one of the routes specified in the plurality of ride offers and passes through the origin candidate point. The method further determines a destination candidate point that satisfies the preference for the get-off point, determines a destination route that passes through the destination candidate point, and determines an optimum route to suggest to the passenger, wherein the optimum route includes both the origin route and the destination route in common.

### BACKGROUND

The present invention relates to a context based ride offer search.

There has been a growing demand for ridesharing, especially in urban areas, as a solution to environmental conservation, economic efficiency, and congestion relief. In the ridesharing, a ridesharing searcher (passenger) needs to select an optimum one of ridesharing proposals (ride offers) from drivers.

### SUMMARY

According to an embodiment of the present invention, there is provided a computer-implemented method for searching for a ride offer. The method includes receiving a plurality of ride offers, wherein each of the plurality of ride offers specifies a route that a vehicle passes along. The method further includes receiving location information of an origin and a destination for a passenger, and a preference of the passenger for at least one of a get-on point, where the passenger gets into the vehicle, and a get-off point, where the passenger gets out of the vehicle. The method further includes determining an origin candidate point being a point in a first predetermined range from the origin, wherein the origin candidate point satisfies the preference for the get-on point. The method further includes determining an origin route being one of the routes specified in the received plurality of ride offers, wherein the origin route passes through the origin candidate point. The method further includes determining a destination candidate point being a point in a second predetermined range from the destination, wherein the destination candidate point satisfies the preference for the get-off point. The method further includes determining a destination route being one of the routes specified in the received plurality of ride offers, wherein the destination route passing through the destination candidate point. The method further includes determining an optimum route to suggest to the passenger, wherein the optimum route includes both the origin route and the destination route in common.

According to another embodiment of the present invention, there is provided a ride offer search apparatus. The ride offer search apparatus includes a ride offer receiver, a preference receiver, an origin candidate point determinator, an origin route determinator, a destination candidate point determinator, a destination route determinator, and an optimum route determinator. The ride offer receiver receives a plurality of ride offers, wherein each ride offer specifies a route that a vehicle passes along. The preference receiver receives location information for an origin and a destination of a passenger, and a preference of the passenger for at least one of a get-on point, where the passenger gets into the vehicle, and a get-off point, where the passenger gets out of the vehicle. The origin candidate point determinator determines an origin candidate point, wherein the origin candidate point is a point in a first predetermined range from the origin, and satisfies the preference for the get-on point. The origin route determinator determines an origin route, wherein the origin route is one of the routes specified in the plurality of ride offers, and passes through the origin candidate point. The destination candidate point determinator determines a destination candidate point, wherein the destination candidate point is a point in a second predetermined range from the destination, and satisfies the preference for the get-off point. The destination route determinator determines a destination route, wherein the destination route is one of the routes specified in the plurality of ride offers, and passes through the destination candidate point. The optimum route determinator determines an optimum route to suggest to the passenger, wherein the optimum route includes both the origin route and the destination route in common.

According to yet another embodiment of the present invention, there is provided a computer program product for searching for a ride offer. The computer program product includes a computer readable storage medium having program instructions embodied therewith. The program instructions are executable by a computer to cause the computer to receive a plurality of ride offers, wherein each of the plurality of ride offers specifies a route that a vehicle passes along. The program instructions are executable by a computer to further cause the computer to receive location information of an origin and a destination for a passenger, and a preference of the passenger for at least one of a get-on point, where the passenger gets into the vehicle, and a get-off point, where the passenger gets out of the vehicle. The program instructions are executable by a computer to further cause the computer to determine an origin candidate point being a point in a first predetermined range from the origin, wherein the origin candidate point satisfies the preference for the get-on point. The program instructions are executable by a computer to further cause the computer to determine an origin route being one of the routes specified in the plurality of ride offers, wherein the origin route passes through the origin candidate point. The program instructions are executable by a computer to further cause the computer to determine a destination candidate point being a point in a second predetermined range from the destination, wherein the destination candidate point satisfies the preference for the get-off point. The program instructions are executable by a computer to further cause the computer to determine a destination route being one of the routes specified in the plurality of ride offers, wherein the destination route passes through the destination candidate point. The program instructions are executable by a computer to further cause the computer to determine an optimum route to suggest to the passenger, wherein the optimum route includes both the origin route and the destination route in common.

According to yet another embodiment of the present invention, there is provided a computer-implemented method for searching for a ride offer. The method includes receiving plural ride offers, each ride offer specifying a route a vehicle passes along. The method further includes receiving a location information on an origin and a destination a passenger desires. The method further includes determining a connecting route being a route connecting the origin and the destination. The method further includes determining an origin route being one of the routes specified in the ride offers, the origin route including a section within a first predetermined range from the origin, the origin route crossing the connecting route. The method further includes determining a destination route being one of the routes specified in the ride offers, the destination route including a section within a second predetermined range from the destination, the destination route crossing the connecting route. The method further includes determining an optimum route to be suggested to the passenger, the optimum route being a combination of the origin route and the destination route.

According to yet another embodiment of the present invention, there is provided a ride offer search apparatus. The ride offer search apparatus includes a ride offer receiver, a location receiver, a connecting route determinator, an origin route determinator, a destination route determinator, and an optimum route determinator. The ride offer receiver receives plural ride offers, each ride offer specifying a route a vehicle passes along. The location receiver receives a location information on an origin and a destination a passenger desires. The connecting route determinator determines a connecting route being a route connecting the origin and the destination. The origin route determinator determines an origin route being one of the routes specified in the ride offers, the origin route including a section within a first predetermined range from the origin, the origin route crossing the connecting route. The destination route determinator determines a destination route being one of the routes specified in the ride offers, the destination route including a section within a predetermined range from the destination, the destination route crossing the connecting route. The optimum route determinator determines an optimum route to be suggested to the passenger, the optimum route being a combination of the origin route and the destination route.

According to yet another embodiment of the present invention, there is provided a computer program product for searching for a ride offer. The computer program product includes a computer readable storage medium having program instructions embodied therewith. The program instructions are executable by a computer to cause the computer to receive plural ride offers, each ride offer specifying a route a vehicle passes along. The program instructions are executable by a computer to further cause the computer to receive a location information on an origin and a destination a passenger desires. The program instructions are executable by a computer to further cause the computer to determine a connecting route being a route connecting the origin and the destination. The program instructions are executable by a computer to further cause the computer to determine an origin route being one of the routes specified in the ride offers, the origin route including a section within a first predetermined range from the origin, the origin route crossing the connecting route. The program instructions are executable by a computer to further cause the computer to determine a destination route being one of the routes specified in the ride offers, the destination route including a section within a second predetermined range from the destination, the destination route crossing the connecting route. The program instructions are executable by a computer to further cause the computer to determine an optimum route to be suggested to the passenger, the optimum route being a combination of the origin route and the destination route.

### BRIEF DESCRIPTION OF THE DRAWINGS

FIGS. 1A, 1B, and 1C depict maps for explaining a ride offer search, in accordance with an exemplary embodiment of the present invention.

FIG. 2 depicts a block diagram of a ride offer search system, in accordance with an exemplary embodiment of the present invention.

FIG. 3 depicts a map showing an origin of a passenger's travel and routes, in accordance with an exemplary embodiment of the present invention.

FIG. 4A depicts a table of the route, in accordance with an exemplary embodiment of the present invention.

FIG. 4B depicts a table of a passing point, in accordance with an exemplary embodiment of the present invention.

FIG. 4C depicts a table of a mesh, in accordance with an exemplary embodiment of the present invention.

FIG. 4D depicts a table of a context index, in accordance with an exemplary embodiment of the present invention.

FIG. 4E depicts a table of a point index, in accordance with an exemplary embodiment of the present invention.

FIG. 4F depicts a table of an efficient route, in accordance with an exemplary embodiment of the present invention.

FIG. 5 depicts a map showing the efficient routes, in accordance with an exemplary embodiment of the present invention.

FIG. 6 is a table of combinations of the routes, in accordance with an exemplary embodiment of the present invention.

FIG. 7 is a flowchart of a preprocessing operation of an index processor, in accordance with an exemplary embodiment of the present invention.

FIG. 8 is a flowchart of a direct ride search operation of a direct ride processor, in accordance with an exemplary embodiment of the present invention.

FIG. 9 is a flowchart of a transfer ride search operation of a transfer ride processor, in accordance with an exemplary embodiment of the present invention.

FIG. 10 depicts an example of a user interface displayed on a passenger terminal, in accordance with an exemplary embodiment of the present invention.

FIG. 11 depicts an example of a hardware configuration of a ride offer search server, in accordance with an exemplary embodiment of the present invention.

### DETAILED DESCRIPTION

Hereinafter, exemplary embodiments of the present invention will be described in detail with reference to the attached drawings.

It is to be noted that the present invention is not limited to these exemplary embodiments to be given below and may be implemented with various modifications within the scope of the present invention. In addition, the drawings used herein are for purposes of illustration, and may not show actual dimensions.

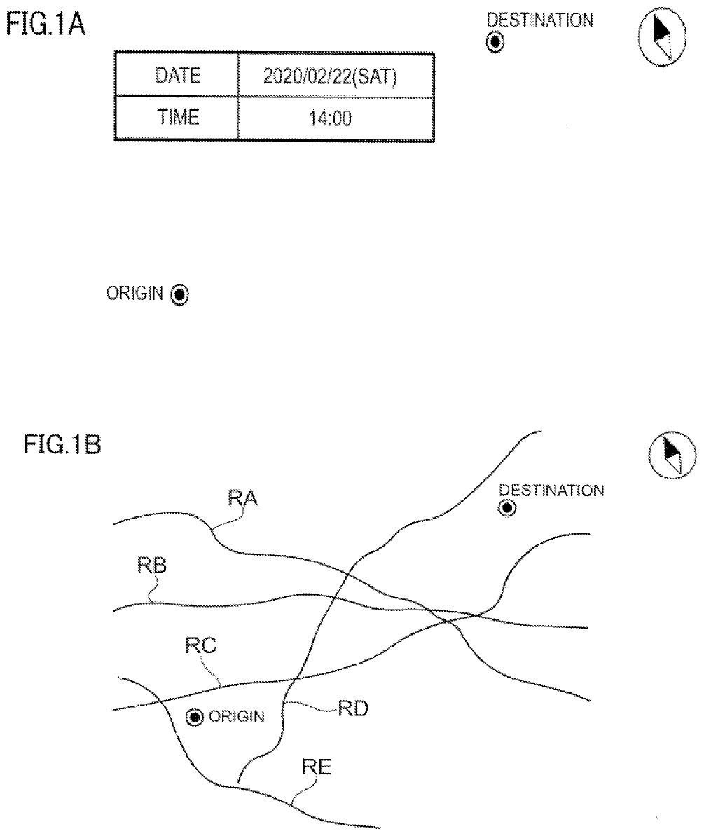

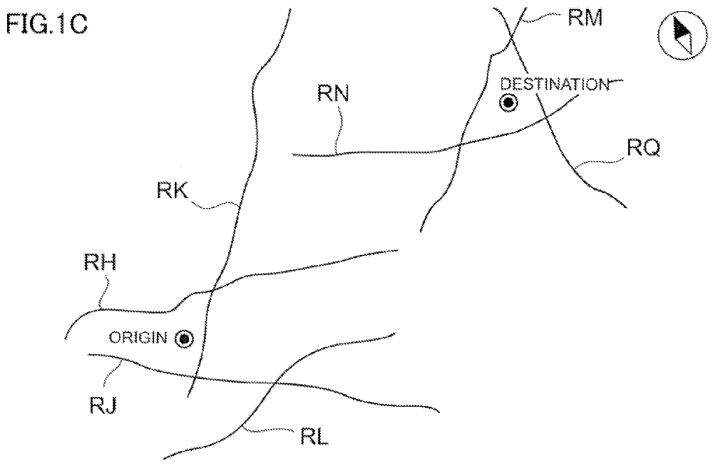

FIGS. 1A, 1B, and 1C depict maps for explaining a ride offer search according to an exemplary embodiment of the present invention. Specifically, FIG. 1A depicts a map showing search conditions for a ride offer. FIG. 1B depicts a map showing routes of ride offers. FIG. 1C depicts a map showing a transfer route.

An example shown in FIG. 1A assumes that a person (passenger) desires to move from an origin to a destination at a certain departure date and time, e.g., 14:00 on Feb. 22, 2020, by using ridesharing. The passenger then needs to know travel schedules (ride offers) of drivers offering a ride for the entire route or a part thereof, to find a desired ride offer. Note that the term “ridesharing” refers to an arrangement in which a passenger travels in a private vehicle driven by a driver, typically an owner of the vehicle, offering a ride for the passenger. Further, the example assumes that when and what path (route) the vehicle travels are known in advance.

Here, the origin and the destination of the passenger's movement (travel) are not always on the route of the ride offer (hereinafter may be referred to simply as the “route”), so that not only the route passing through the exact origin and the exact destination but also the route passing near the origin and near the destination are subject to search in the present exemplary embodiment.

In FIG. 1B, the map shows multiple routes RA, RB, RC, RD and RE. Here, the routes RC and RD respectively pass near the origin and near the destination of the passenger's travel, so that the routes RC and RD may be candidate routes for the passenger. Note that the routes RA-RE are routes respectively offered by ride offers A, B, C, D and E. For example, in the ride offer C, the vehicle passes along the route RC. Further, if the passenger selects the route RC, the passenger is required to move on foot from the origin to a point on the route RC to get on the vehicle of the ride offer C. The passenger is also required to move on foot to the destination after getting off the vehicle on another point on the route C.

The present exemplary embodiment may include three steps to find an optimum route(s). More specifically, the present exemplary embodiment firstly searches for an origin route, which is a route passing through or near the origin, to determine an origin route candidate(s). The present exemplary embodiment secondly searches for a destination route, which is a route passing through or near the destination, to determine a destination route candidate(s). The present exemplary embodiment finally calculates an optimum route(s), which is a route(s) to be suggested to the passenger, matching both of search conditions, i.e., the origin route candidate(s) and the destination route candidate(s). Hereinafter the ride offer including the optimum route is referred to as the optimum ride offer. Further, the optimum ride offer can be regarded as a search result. The details of the calculation of the optimum route will be described later.

Further, when the destination of the passenger's travel cannot be reached from the origin of the passenger's travel with a single route, i.e., a direct route, the passenger can transfer to another vehicle. That is to say, the passenger may take multiple (two or more) routes to move from the origin to the destination by changing the vehicles, if needed. Hereinafter, the multiple routes to be taken by the passenger in a single travel may be referred to as a transfer route. Here, the routes involved in the transfer route are not necessarily be intersected; the transfer route may involve no intersection of the routes.

In FIG. 1C, the map shows multiple routes RH, RJ, RK, RL, RM, RN and RQ. The example shown in FIG. 1C assumes that a pair of the routes RH and RM is the transfer route. The pair of the routes RH and RM involves no intersection. In the present exemplary embodiment, the transfer route is determined based on proximity of the routes to reduce the distance of a transfer section where the passenger is required to move on foot. The details of the calculation of the transfer route will be described later.

Further, in the present exemplary embodiment, the passenger can search for a ride offer based on the passenger's preference expressed in a context (text). Hereinafter, the context indicating the passenger's preference is referred to as a “preference context”. The preference context may indicate an attribute of a get-on point and/or a get-off point. The get-on point refers to a point on a particular route where the passenger gets on the vehicle of the ride offer. The get-off point refers to a point on a particular route where the passenger gets off the vehicle of the ride offer. For example, the passenger may want to get on the vehicle at a point near a convenience store or a cafe to spend wait time for the arrival of the vehicle. In another example, the passenger may want to get off the vehicle at a point connected with a pedestrian path, so that the passenger can move safely. In still another example, the passenger may want to get off the vehicle at a point having a ridesharing history, so that the passenger can feel safe. Here, if the passenger searches for a ride offer based on a preference context “a cafe”, the route passing near a cafe is to be selected.

Further, the passenger may have multiple preference contexts for the get-on point and/or the get-off point. If the multiple preference contexts are specified by the passenger, a route including the point(s) satisfying the multiple preference contexts may be a candidate route.

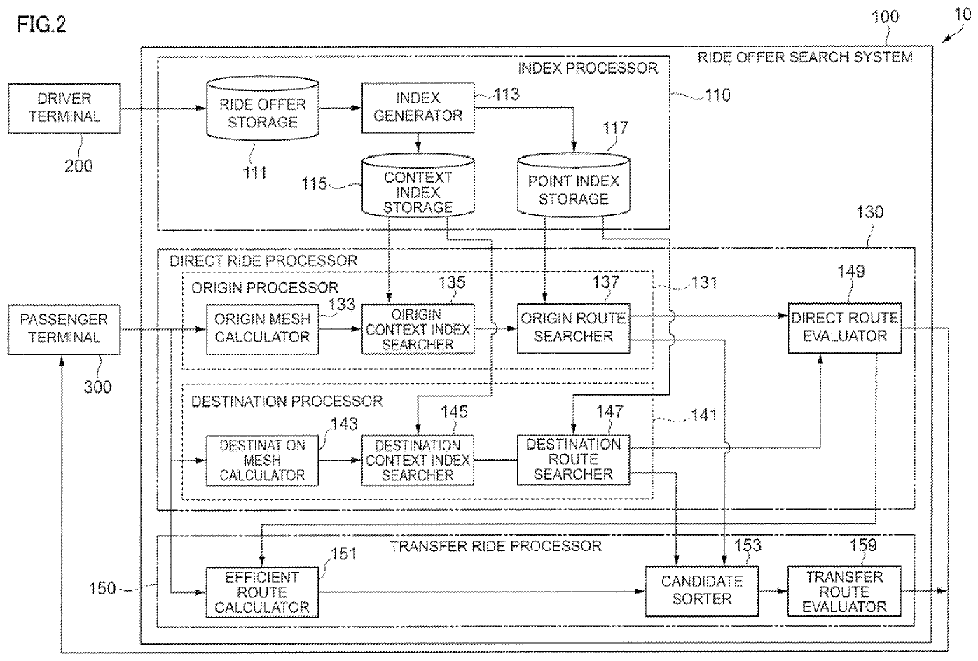

FIG. 2 depicts a block diagram of a ride offer search system 10 according to the exemplary embodiment. As shown in FIG. 2, the ride offer search system 10 may include a ride offer search server 100, a driver terminal 200, and a passenger terminal 300. The ride offer search server 100 is a server searching for a ride offer. The driver terminal 200 is a terminal operated by the driver to send a ride offer to the ride offer search server 100. The passenger terminal 300 is a terminal operated by the passenger to send a search request including a location information on the origin and the destination and information on the preference context, and to receive the search result, i.e., the optimum ride offer. Note that although a single driver terminal 200 and a single passenger terminal 300 are shown in FIG. 2, the ride offer search system 10 may include multiple driver terminals 200 and multiple passenger terminals 300. Further, the ride offer search server 100 searches for the optimum ride offer among multiple ride offers.

The ride offer search server 100 may include an index processor 110, a direct ride processor 130, and a transfer ride processor 150. The index processor 110 conducts a preprocessing operation that processes a context index and a point index. The direct ride processor 130, in response to the search request, searches for ride offers having a direct route to output the optimum ride offer. The transfer ride processor 150 searches for ride offers having a transfer route.

The index processor 110 may include a ride offer storage 111, an index generator 113, a context index storage 115, and a point index storage 117.

The ride offer storage 111 stores ride offers received from the driver terminal 200, i.e., from the driver. Each ride offer may include information on a driver's ID, a type of a vehicle, a schedule (date and time) of the travel, and a route. The information on the route may further include information on passing points. Note that the passing points refer to points on the route where the passenger can get on and get off the vehicle. Here, the passing point may be an area within a predetermined range (e.g., a radius of 50 m) rather than an exact point. The starting point and the destination point of the driver's route are ones among the passing points. For example, the passing points may be a place as a landmark, such as a shop, a restaurant, an intersection of a road, a station rotary, or an entrance of a park. Note that the above get-on point and get-off point are selected among the passing points.

The index generator 113 generates the context index and the point index from the ride offers stored in the ride offer storage 111. The context index storage 115 stores the context index. The point index storage 117 stores the point index. The details of the context index and the point index will be described later.

The direct ride processor 130 may include an origin processor 131, a destination processor 141, and a direct route evaluator 149.

The origin processor 131 calculates origin route candidate(s). The origin processor 131 may include an origin mesh calculator 133, an origin context index searcher 135, and an origin route searcher 137. The origin mesh calculator 133 calculates meshes (described later) as to the origin of the passenger's travel. The origin context index searcher 135 searches for the points which are located near the origin and match the preference context, using the context index stored in the context index storage 115. The origin route searcher 137 searches for the origin route candidate(s), using the point index stored in the point index storage 117. The details of the operation of the origin processor 131 will be described later.

The destination processor 141 calculates destination route candidate(s). The destination processor 141 may include a destination mesh calculator 143, a destination context index searcher 145, and a destination route searcher 147. The destination mesh calculator 143 calculates meshes as to the destination of the passenger's travel. The destination context index searcher 145 searches for the points which are located near the destination and match the preference context, using the context index stored in the context index storage 115. The destination route searcher 147 searches for the destination route candidate(s), using the point index stored in the point index storage 117. The details of the operation of the destination processor 141 will be described later.

The direct route evaluator 149 evaluates the origin route candidate(s) from the origin route searcher 137 and the destination route candidate(s) from the destination route searcher 147. If the direct route evaluator 149 determines that a common route(s) between the origin route candidate(s) and the destination route candidate(s) exists, the direct route evaluator 149 outputs the optimum ride offer(s) having the common route(s) to the passenger terminal 300, i.e., to the passenger. If the direct route evaluator 149 determines that no common route exists, the direct route evaluator 149 outputs a calculation order to the transfer ride processor 150.

The transfer ride processor 150 may include an efficient route calculator 151, a candidate sorter 153, and a transfer route evaluator 159.

The efficient route calculator 151 receives the calculation order from the direct route evaluator 149 to calculate an efficient route(s). The efficient route calculator 151 calculates all of the efficient routes connecting the origin and the destination of the passenger's travel while satisfying a predetermined condition (described later).

The candidate sorter 153 sorts the origin route candidate(s) and the destination route candidate(s) using the efficient route determined by the efficient route calculator 151. The sorting of the origin route candidate(s) and the destination route candidate(s) will be described later.

The transfer route evaluator 159 evaluates the ride offer candidates from the candidate sorter 153 to output the optimum ride offer(s) to the passenger terminal 300, i.e., to the passenger.

Note that the ride offer storage 111 is an example of the claimed ride offer receiver. The origin mesh calculator 133 is an example of the claimed preference receiver and the location receiver. The origin context index searcher 135 is an example of the claimed origin candidate point determinator. The origin route searcher 137 is an example of the claimed origin route determinator. The destination context index searcher 145 is an example of the claimed destination candidate point determinator. The destination route searcher 147 is an example of the claimed destination route determinator. The direct route evaluator 149 is an example of the claimed optimum route determinator.

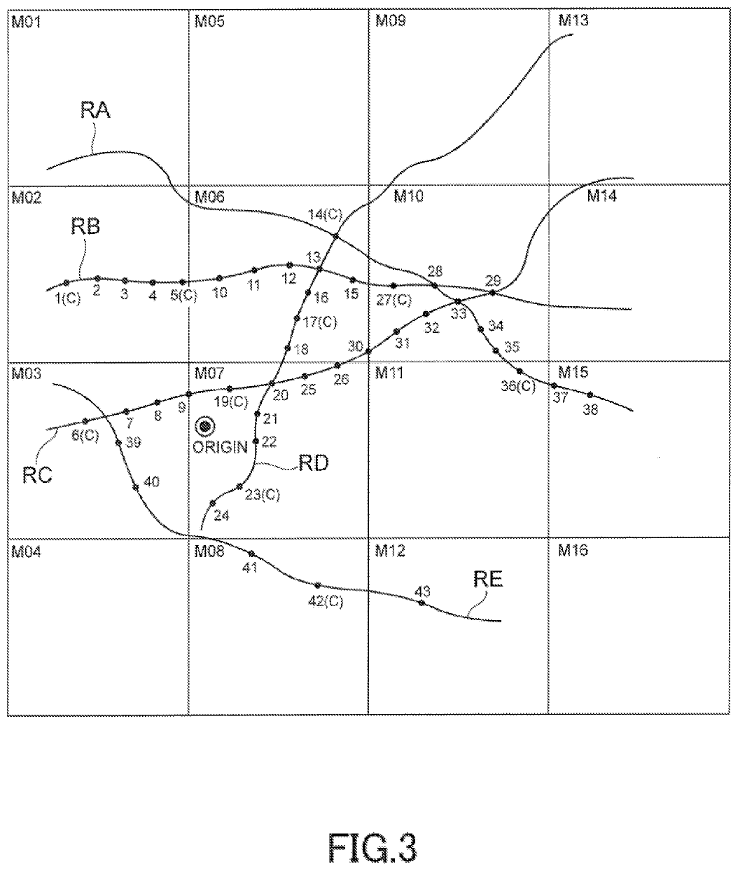

FIG. 3 depicts a map showing the origin of the passenger's travel and the routes RA-RE. Hereinafter, referring to FIG. 3, the passing points on the routes RA-RE will be explained in detail. The example shown in FIG. 3 assumes that the passenger searches for a ride offer matching the preference context “a cafe”.

As shown in FIG. 3, the routes RA-RE include multiple passing points 1-43. In FIG. 3, some of the passing points are denoted with (c), which indicates that the passing point is near a cafe. In other words, the passing points denoted with (c) meet the passenger's request expressed in the context.

Further, the map shown in FIG. 3 is divided into areas having a substantially square or rectangular shape. Specifically, each divided area constitutes a mesh of a net. The map shown in FIG. 3 includes meshes M01-M16. The edges of respective meshes M01-M16 are along longitude or latitude. Although the illustration is omitted, the meshes are also drawn in an area including the destination of the passenger's travel.

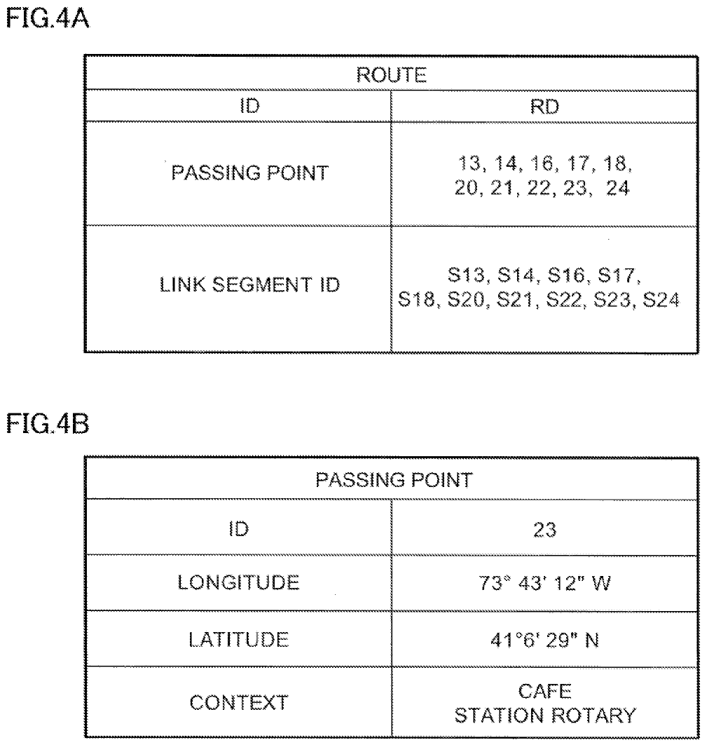

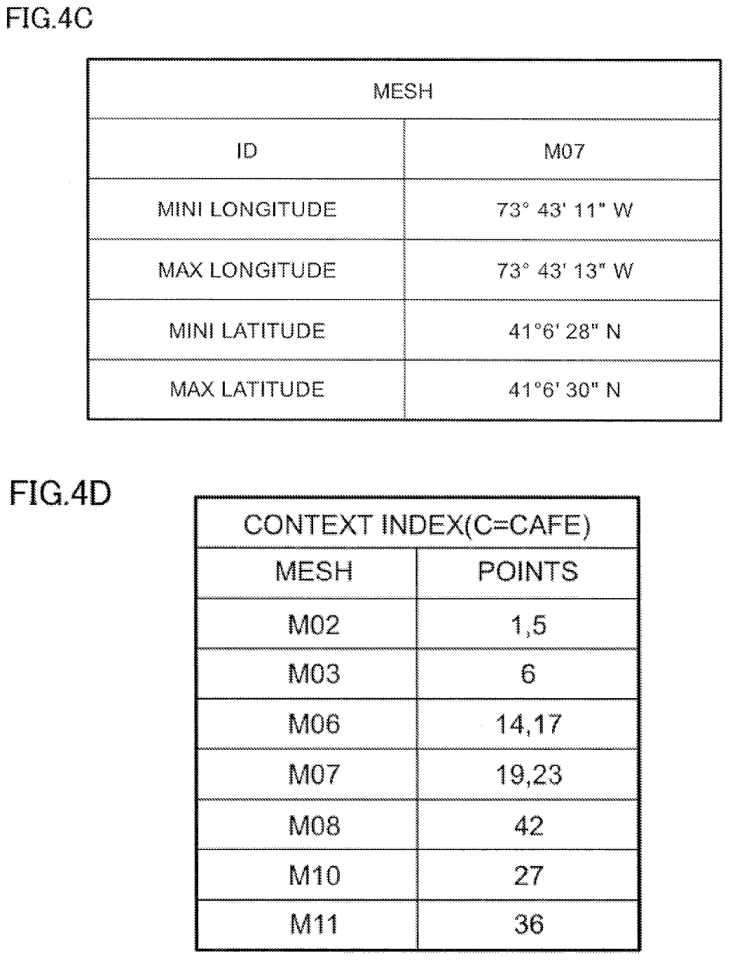

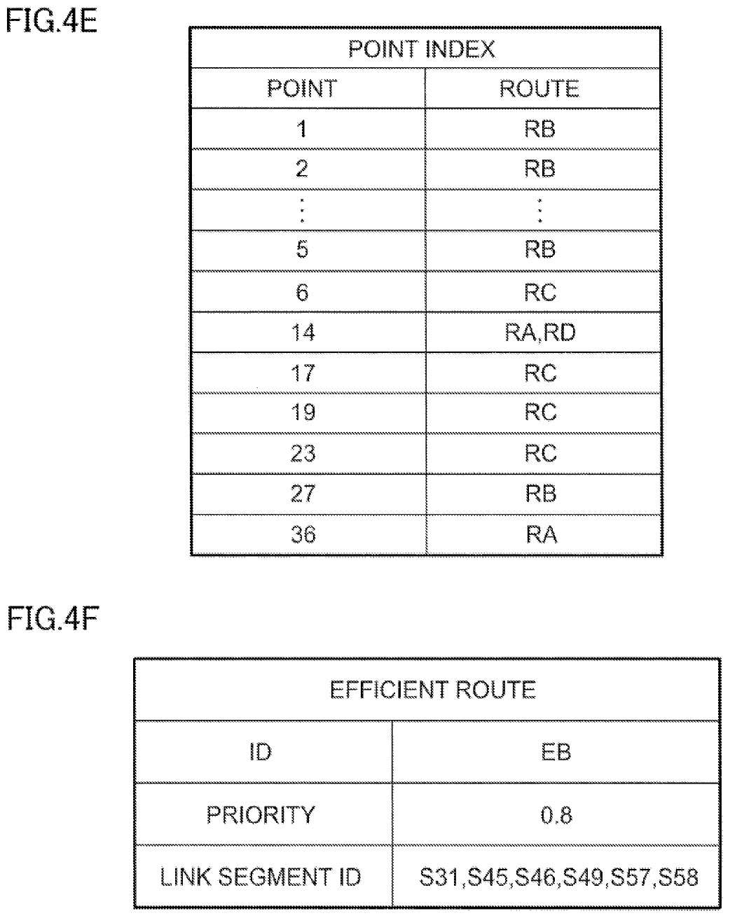

FIG. 4A depicts a table of the route. FIG. 4B depicts a table of the passing point. FIG. 4C depicts a table of the mesh. FIG. 4D depicts a table of the context index. FIG. 4E depicts a table of the point index. FIG. 4F depicts a table of the efficient route.

Hereinafter, referring to FIGS. 3 and 4A-4F, parameters for the ride offer search server 100 to calculate the optimum ride offer will be explained in detail.

As shown in FIG. 4A, the table of the route may include an ID of the subject route, passing points on the subject route, and a link segment ID of the subject route. Here, the link segment ID is an ID number for a link segment, which is a line connecting two adjacent passing points on the route. The link segment is used for a calculation of the efficient route (described later). The table of the route as shown in FIG. 4A may be stored in the ride offer storage 111 (refer to FIG. 2).

The ID of the route shown in FIG. 4A is RD. The passing points are 13, 14, 16, 17, 18, 20, 21, 22, 23 and 24. The link segment IDs are S13, S14, S16, S17, S18, S20, S21, S22, S23 and S24.

As shown in FIG. 4B, the table of the passing point may include an ID of the subject passing point, the longitude and the latitude of the subject passing point, and the context of the subject passing point. The ID of the passing point shown in FIG. 4B is 23. The passing point 23 is on 73° 43′ 12″ west longitude and 41° 6′ 29″ north latitude. Further, the context, i.e., the attribute, of the passing point 23 is “cafe” and “station rotary”. Here, the information on the passing point may be acquired by existing techniques for map analysis. The table of the passing point as shown in FIG. 4B may be stored in the ride offer storage 111 (refer to FIG. 2).

As shown in FIG. 4C, the table of the mesh includes an ID of the subject mesh, the minimum longitude, the maximum longitude, the minimum latitude, and the maximum latitude. The ID of the mesh shown in FIG. 4C is M07. The mesh M07 expands from 73° 43′ 11″ to 73° 43′ 13″ west longitude, and from 41° 6′ 28″ to 41° 6′ 30″ north latitude. The table of the mesh as shown in FIG. 4C may be stored in the index generator 113 (refer to FIG. 2).

As shown in FIG. 4D, the table of the context index includes the passing points matching the subject preference context. Note that the context index defines the passing points sorted by the mesh. Further, the passing points in the table shown in FIG. 4D are selected from the whole passing points with the preference context specified in the search request. The preference context of the table shown in FIG. 4D is “cafe” (C=cafe). For example, the mesh M07 includes the passing points 19 and 23 matching the preference context “cafe”. The table of the context index may be stored in the context index storage 115 (refer to FIG. 2).

Here, the meshes in the table shown in FIG. 4D are selected from the meshes shown in FIG. 3. The selected meshes cover or are close to the origin of the passenger's travel. The mesh M07 corresponds to an origin mesh (described later). The meshes M02, M03, M04, M06, M08, M10 M11 and M12 correspond to adjacent meshes (described later).

Note that the context indexes are prepared for each preference context. In the search operation, the context index is determined according to each preference context specified in the search request to acquire candidate points (described later). Here, if the multiple preference contexts are included in a single search request, the candidate points may be narrowed down with multiple context indexes. That is to say, the candidate points may be narrowed down by using multiple search conditions such as “and”, “or”, “and/or” to combine the multiple context indexes.

As shown in FIG. 4E, the table of the point index includes the passing points shown in the table of FIG. 4D, and the routes of the ride offers including the subject passing points. Note that the point index defines the routes sorted by the passing point. For example, in the table shown in FIG. 4E, the point 14 is associated with the routes RA and RD. This means that the point 14 is included in the routes RA and RD (refer to FIG. 3). The table of the point index may be stored in the point index storage 117 (refer to FIG. 2). The passing point shown in the table of FIG. 4E is an example of the claimed origin candidate point.

In the present exemplary embodiment, the calculation of the optimum route utilizes the multiplex indexes, i.e., the context index and the point index, to reduce the calculation costs. Here, as mentioned above, in the context index, the passing points are selected with the preference context and filtered by the mesh. Further, as mentioned above, in the point index, the routes are sorted by the passing points. The route having the subject passing point can be identified with the point index.

Hereinafter, the origin mesh and the adjacent meshes will be described in detail. The origin mesh is a mesh covering the origin of the passenger's travel. The adjacent meshes are meshes being adjacent to the origin mesh. In the example shown in FIG. 3, the mesh M07 covering the origin is the origin mesh. Further, the meshes M02, M03, M04, M06, M08, M10, M11 and M12 being adjacent to the mesh M07 are the adjacent meshes. Note that the meshes M02, M03, M04, M06, M08, M10, M11 and M12 surround the origin mesh M07.

The passing points included in the origin mesh can be deemed as the passing points near the origin. That is to say, using the origin mesh can eliminate the need for an accurate calculation of the distance between the origin and the respective passing points. This can reduce the calculation cost to determine the passing points near the origin. Note that in the existing technology, all passing points on the routes passing near the origin or the destination are simply subject to calculation, so that the calculation is performed on any completely unrelated ride offer too, which is unnecessary.

Using the adjacent meshes allows to avoid missing the point(s) located near the origin and outside of the origin mesh. More specifically, focusing on the single origin mesh alone may result in missing the point(s) being close to the origin and located in the adjacent meshes. The points detected (covered) by a mesh are varied depending on settings for the mesh; with a single mesh in particular, such mesh settings significantly affect accuracy of the point detection. Using the adjacent meshes can reduce influence of the mesh settings on accuracy of the point detection.

The passing points determined with the origin mesh and the adjacent meshes may be further narrowed down by the distance between the respective points and the origin. That is to say, the points are filtered with a predetermined distance, i.e., walking distance from the origin of the passenger's travel. This may reduce the calculation costs for the ride offer search.

As shown in FIG. 4F, the table of the efficient route may include an ID of the subject efficient route, a priority of the subject efficient route, and link segment IDs of the subject efficient route. Here, the priority is a parameter to determine the transfer route (described later). The table of the efficient route as shown in FIG. 4F may be stored in the efficient route calculator 151 (refer to FIG. 2). Note that the link segments are used for determining the length of the subject efficient route, such as by using the number of the link segments.

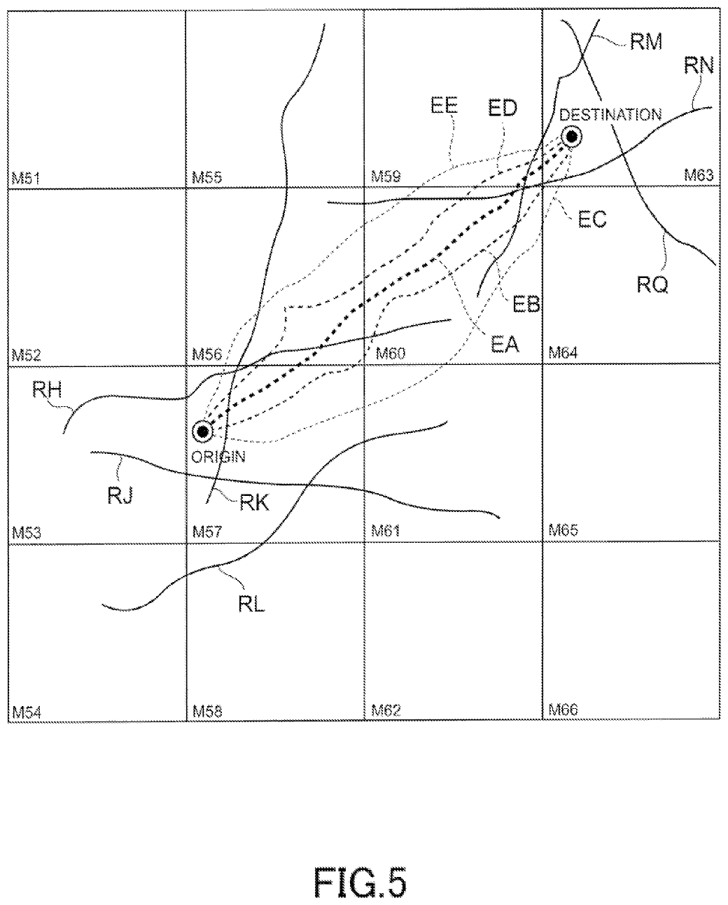

FIG. 5 depicts a map showing the efficient routes. Hereinafter, referring to FIG. 5, the calculation of the optimum route involving the transfer route will be explained in detail. The example shown in FIG. 5 assumes that no direct route can be found, so that the passenger is required to take the transfer route. FIG. 5 shows the routes RH, RJ, RK and RL passing near the origin of the passenger's travel, and the routes RM, RN and RQ passing near the destination of the passenger's travel.

The calculation of the transfer route uses the efficient route. The efficient route refers to the shortest route from the origin to the destination of the passenger's travel or a route having a length within a predetermined range from the length of the shortest route. Note that the efficient routes are defined independently of the routes in the ride offers. FIG. 5 shows efficient routes EA, EB, EC, ED and EE. The efficient route EA is the shortest route, and the efficient routes EB-EE have length not more than 1.5 times of the length of the efficient route EA. Note that the efficient routes EA-EE are examples of the claimed connecting route and sub-routes. The length not more than 1.5 times of the length of the efficient route EA is an example of the claimed predetermined relationship.

Here, each efficient route is assigned a priority to evaluate the route for calculation of the optimum route. In the shown example, the priority is assigned based on the length of the subject efficient route. More specifically, a higher priority is assigned to an efficient route having a shorter length. The priority can be the inverse of the length of the subject efficient route. In FIG. 5, the widths of the efficient routes EA-EE vary depending on the respective priorities. More specifically, if the priority of the subject efficient route is large, the width thereof is wide.

To determine the transfer route, the efficient routes and their priorities are used. More specifically, the exemplary embodiment prioritizes the routes crossing or overlapping one or more the efficient routes, because the route crossing (overlapping) one or more the efficient routes can be deemed as the routes being close to the shortest route. The priority of the subject route is determined by the priority of the efficient route the subject route crosses or overlaps. Note that if the subject route crosses multiple efficient routes, the priority of the subject route can be determined from the highest priority among the priorities of the multiple efficient routes. Further, if the subject route has multiple intersections with the single efficient route, the priority of the subject route can be increased. Note that the number of the multiple intersections is an example of the origin-oriented manner and a destination-oriented manner.

Here, in the calculation of the transfer route, the routes passing near the origin of the passenger's travel and the routes passing near the destination of the passenger's travel are respectively sorted according to their priorities. The calculation of the transfer route is conducted on a combination of one of the prioritized routes passing near the origin and one of the prioritized routes passing near the destination.

In the example shown in FIG. 5, the routes which pass near the origin and cross at least one of the efficient routes EA-EE are the routes RH and RK. Similarly, the routes which pass near the destination and cross at least one of the efficient routes EA-EE are the routes RM and RN. The shown example then eliminates the routes RJ, RL and RQ, and selects the combination of the remaining routes, i.e., one of a group of the routes RH and RK sorted sequentially from the highest priority, and one of a group of the routes RM and RN sorted sequentially from the highest priority, to calculate a cost value using a cost function.

The cost function can be defined as follows:

C(rorO,rorD,dOD,L)

where rorO is the distance from the origin to the subject route passing near the origin, and rorD is the distance from the subject route passing near the destination to the destination, dOD is the distance of the shortest path between the subject route passing near the origin and the subject route passing near the destination, and L is the length of a ride sharing section in the subject routes. Here, if an intersection occurs in the subject routes, dOD is set to zero. When a combination of the subject routes meets a predetermined condition, e.g., when the combination is found to have the minimum cost value, the combination is set to the optimum ride offer.

Note that rorO is an example of the claimed length of a path between the origin and the origin route. Further, rorD is an example of the claimed length of a path between the destination route and the destination. Further, dOD is an example of the claimed length of a shortest path between the origin route and the destination route. The cost value is an example of the claimed score. The paths between the origin and the subject route passing near the origin, between the subject route passing near the destination and the destination, between the subject route passing near the origin and the subject route passing near the destination are an example of the claimed walking path. The ride sharing section in the subject routes is an example of the claimed ride path.

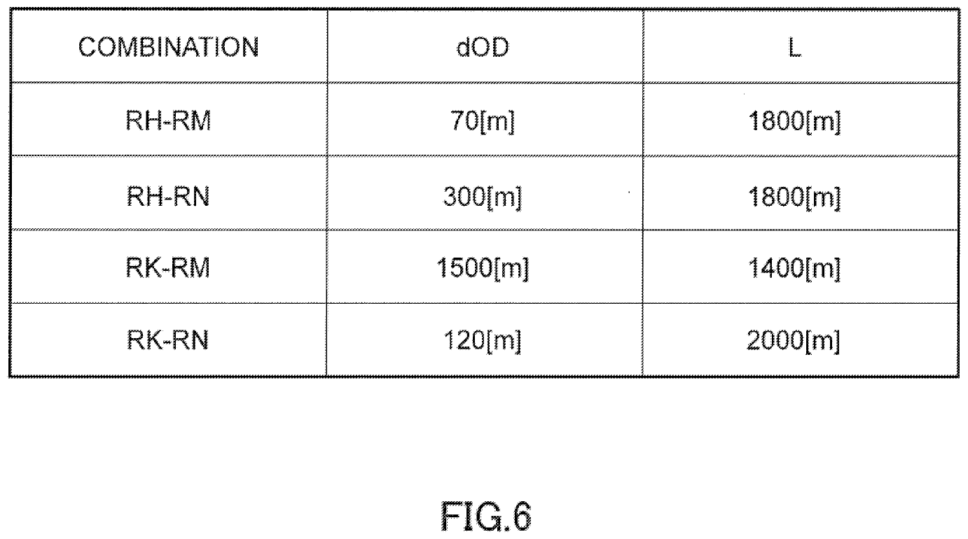

FIG. 6 is a table of combinations of the routes according to the exemplary embodiment. In the example shown in FIG. 6, the cost functions can be defined as follows:

C=100*(rorO+rorD+dOD)+L

The above cost function represents that the walking distance, i.e., rorO, rorD, and dOD, is weighted 100 times the traveling distance L on the vehicle. In the example shown in FIG. 6, the combination of the route RH and the route RM has the minimum cost value, so that the combination of the routes RH and RM will be the optimum route.

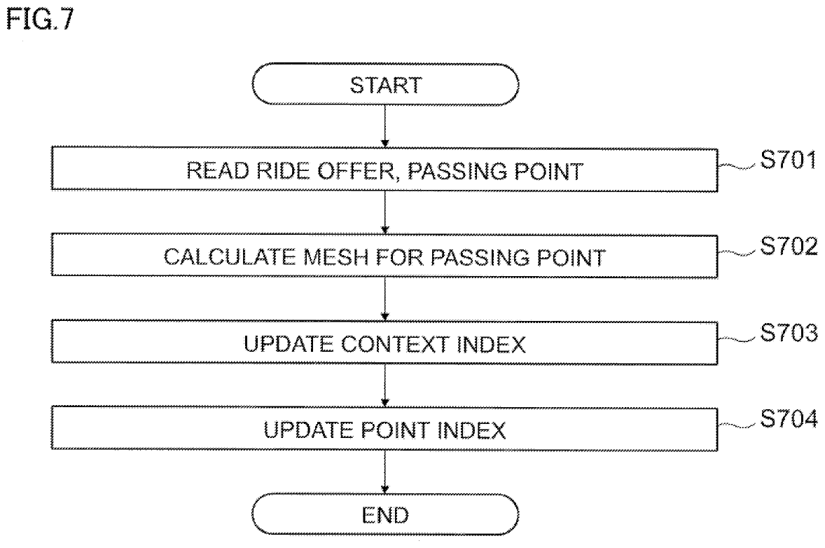

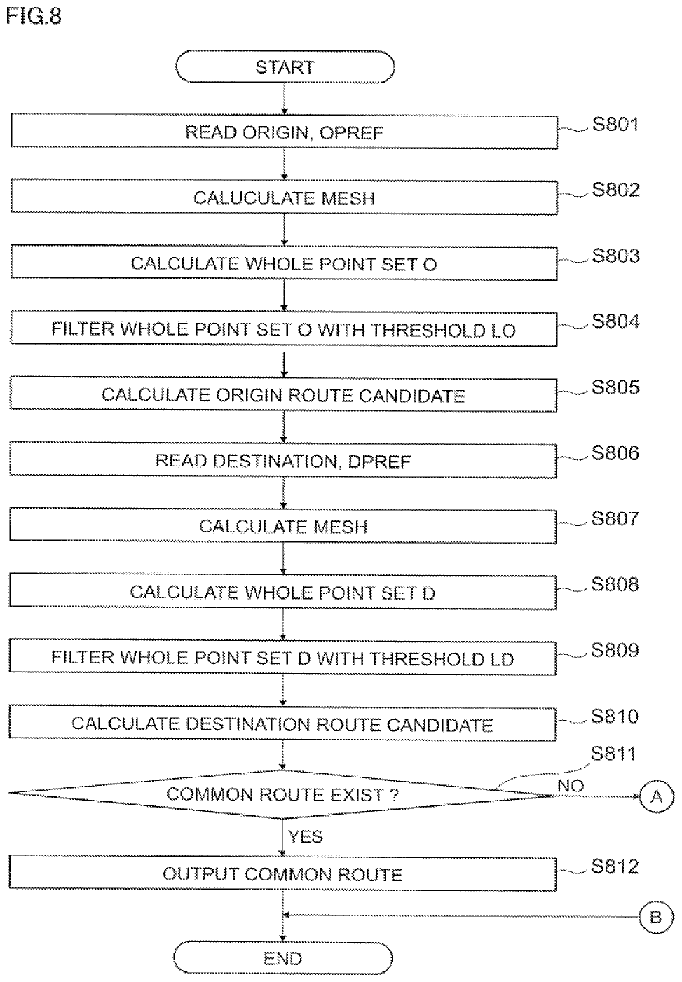

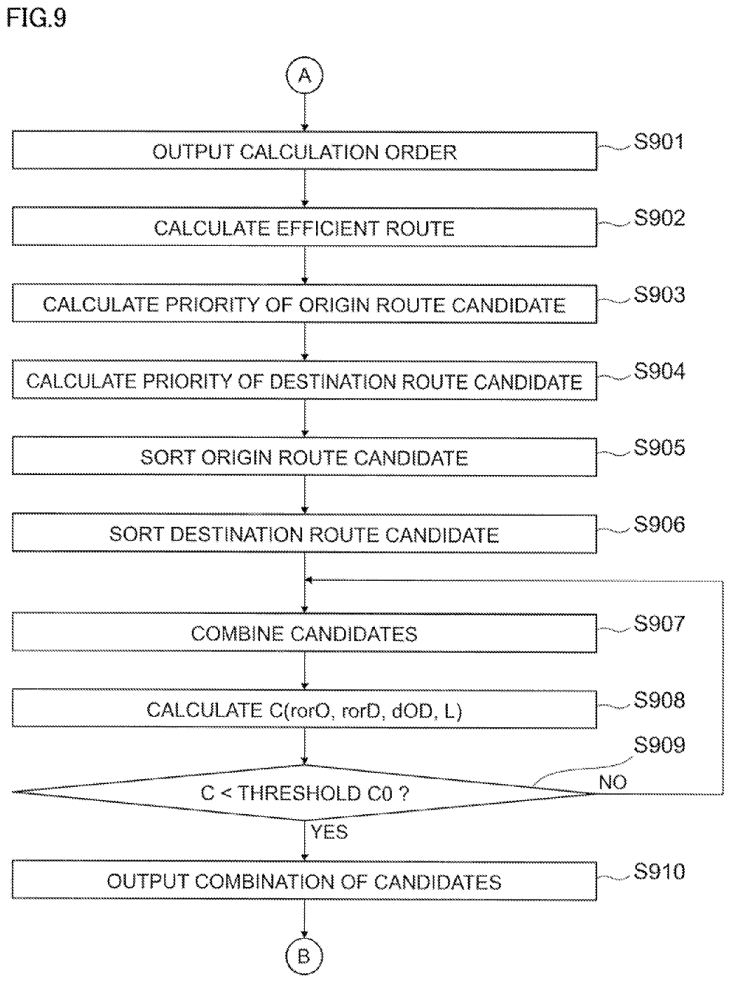

FIG. 7 is a flowchart of the preprocessing operation of the index processor 110 according to the exemplary embodiment. FIG. 8 is a flowchart of a direct ride search operation of the direct ride processor 120 according to the exemplary embodiment. FIG. 9 is a flowchart of a transfer ride search operation of the transfer ride processor 150 according to the exemplary embodiment. Referring to FIGS. 3, 7, 8 and 9, an operation of the ride offer search server 100 according to the exemplary embodiment will be explained.

Referring to FIGS. 3 and 7, the preprocessing operation of the index processor 110 will be explained. The example shown in FIG. 7 assumes that the ride offer storage 111 stores the ride offers sent from the driver terminal 200, the context index storage 115 stores the context indexes (refer to FIG. 4D), and the point index storage 117 stores the point index (refer to FIG. 4E).

The index generator 113 firstly reads the ride offers (refer to FIG. 4A) and the passing points (refer to FIG. 4B) from the ride offer storage 111 (step 701) to find new ride offers and new passing points which have not been preprocessed. The index generator 113 then calculates the meshes of the respective new passing points (step 702). Specifically, the index generator 113 determines the mesh ID of the mesh where the new passing point is located, using the table of the mesh (refer to FIG. 4C).

Next, the index generator 113 updates the context index (refer to FIG. 4D) and stores it in the context index storage 115 (step 703). Specifically, the index generator 113 adds the new passing point having the subject context and the mesh ID of the corresponding mesh covering the new passing point, to the context index in the context index storage 115.

Next, the index generator 113 then updates the point index (refer to FIG. 4E) and stores it in the point index storage 117 (step 704). Specifically, the index generator 113 adds the new passing point with a corresponding route(s) to the point index in the point index storage 117.

Referring to FIGS. 3 and 8, the direct ride search operation of the direct ride processor 120 will be explained. The example shown in FIG. 8 assumes that passenger specifies the origin, the destination, and preference contexts as to the get-on point and the get-off point in the search request. In this example, the preference context of the get-on point is “near a cafe”, and the preference context of the get-off point is “connected with a sidewalk”.

The origin mesh calculator 133 firstly retrieves the passenger's origin and the preference for the get-on point (OPREF) from the search request (step 801). The origin mesh calculator 133 then calculates the origin mesh and the adjacent meshes (step 802).

Next, the origin context index searcher 135 calculates a whole point set O using the context index (step 803). The whole point set O includes all passing points included in the origin mesh or the adjacent meshes and matching the preference specified in the search request. The origin context index searcher 135 then filters the whole point set O with a threshold LO (step 804). Specifically, the origin context index searcher 135 identifies the passing point(s), from the whole point set O, that is located within the predetermined distance (=the threshold LO) from the origin of the passenger's travel. The origin route searcher 137 then calculates the origin route candidate(s) using the point index (step 805). The origin route candidate is a route passing through the point included in the filtered whole point set O in step 804.

The destination mesh calculator 143 retrieves the passenger's destination and preference for the get-off point (DPREF) from the search request (step 806). The destination mesh calculator 143 then calculates the destination mesh and the adjacent meshes (step 807).

Next, the destination context index searcher 145 calculates a whole point set D (step 808). The whole point set D includes all passing points included in the destination mesh or the adjacent meshes and matching the preference specified in the search request. The destination context index searcher 145 then filters the whole point set D with a threshold LD (step 809). Specifically, the destination context index searcher 145 identifies the point(s), from the whole point set D, that is located within a predetermined distance (=the threshold LD) from the destination of the passenger's travel. The destination route searcher 147 then calculates the destination route candidate(s) using the point index (step 810). The destination route candidate is a route passing through the point included in the filtered whole point set D in step 810.

Next, the direct route evaluator 149 determines whether a common route exists between the origin route candidate(s) and the destination route candidate(s) (step 811). In other words, the direct route evaluator 149 determines whether at least one route is included in the origin route candidate(s) and the destination route candidate(s) in common. If the common route exists (Yes in step 811), the direct route evaluator 149 outputs the common route as the optimum ride offer, to the passenger terminal 300 (step 812).

Note that the origin mesh and the adjacent meshes are examples of the claimed first predetermined range and the claimed divided areas. The origin mesh is an example of the claimed origin area. The adjacent meshes of the origin mesh are examples of the claimed adjacent area. The destination mesh and the adjacent meshes are examples of the claimed second predetermined range. The whole point set O is an example of the claimed origin candidate point. The whole point set D is an example of the claimed destination candidate point. The origin route candidate is an example of the claimed origin route. The destination route candidate is an example of the claimed destination route. The common route is an example of the claimed optimum route. The threshold LD is an example of the claimed predetermined distance. The context index is an example of the claimed preference relationship. The point index is an example of the claimed route relationship.

Here, referring to FIGS. 3 and 9, the transfer ride search operation of the transfer ride processor 150 will be explained.

If a common route does not exist (No in step 811), the direct route evaluator 149 outputs the calculation order to the efficient route calculator 151 (step 901). The efficient route calculator 151 then calculates the efficient routes (step 902). The efficient route calculator 151 then calculates priorities of the origin route candidates (step 903). The efficient route calculator 151 also calculates priorities of the destination route candidates (step 904). The candidate sorter 153 then sorts the origin route candidates according to their priorities (step 905). Specifically, the candidate sorter 153 arranges the origin route candidates in descending order of the priority. The candidate sorter 153 also sorts the destination route candidates according to their priorities (step 906). Specifically, the candidate sorter 153 arranges the destination route candidates in descending order of the priority.

Next, the transfer route evaluator 159 combines one of the prioritized origin route candidates having the highest priority and one of the prioritized origin route candidates having the highest priority (step 907). The transfer route evaluator 159 then calculates a cost value gained by the cost function (step 908). The transfer route evaluator 159 then compares the gained cost value with a threshold CO (step 909). If the calculated cost function is smaller than the threshold CO (Yes in step 909), the transfer route evaluator 159 outputs the combination of the one of the origin route candidates and the one of the destination route candidates as the optimum route, to the passenger terminal 300 (step 910). Here, if the calculated cost function is equal to or larger than the threshold CO (No in step 909), the transfer route evaluator 159 combines another one of the origin route candidates and another one of the destination route candidates having the next highest priority (step 907). Note that the combination of the one of the origin route candidates and the one of the destination route candidates is an example of the claimed another optimum route.

Here, the above example produces the multiplex indexes based on the preference context in advance and uses the multiplex index in searching for a ride offer based on the preference context. This may reduce the calculation cost of the search, in particular the calculation cost as to the transfer route. Further, the above example enables a fast search for the ride offer by using the preference context, and contributes to, for example, implementation of more convenient user applications. Not only the search for the direct route but also the search for the transfer route can be performed fast. In the above mentioned example, the passenger may obtain the search result in real time.

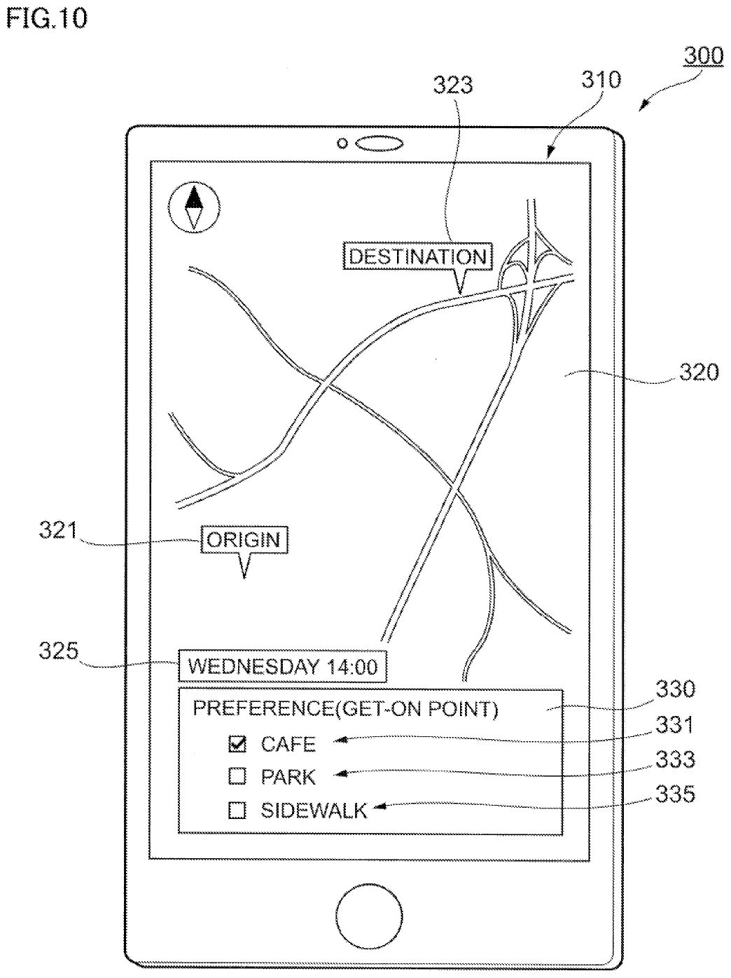

FIG. 10 depicts an example of a user interface 310 displayed on the passenger terminal 300. Referring to FIG. 10, the user interface 310 displayed on the passenger terminal 300 will be explained. As shown in FIG. 10, the user interface 310 may include an area map 320 and a preference indicator 330. In the shown example, the area map 320 includes an origin pointer 321 indicating the origin of the passenger's travel, a destination pointer 323 indicating the destination of the passenger's travel, and a date and time indicator 325 indicating timing, i.e., date and time, of the passenger's travel. The preference indicator 330 is an area to receive the passenger's preference. In the shown example, the preference indicator 330 is for the preference for the get-on point. The preference indicator 330 includes multiple images of options regarding the preference, i.e., a cafe option image 331, a park option image 333, and a sidewalk option image 335. The passenger may check the image(s) to specify the preference for the get-on point. Although illustration is omitted, the preference context indicator 330 can show options regarding the preference for the get-off point for selection by the passenger.

Note that the passenger terminal 300 is an example of the claimed output terminal. The user interface 310 is an example of the claimed image.

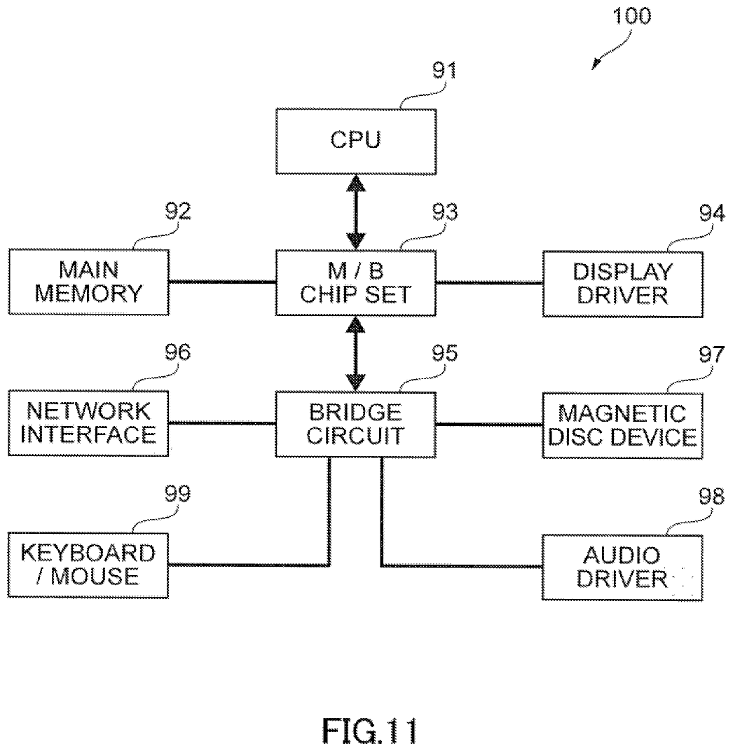

FIG. 11 depicts an example of a hardware configuration of the ride offer search server 100 in the exemplary embodiment.

Referring to FIG. 11, a hardware configuration of the ride offer search server 100 will be described in detail. As shown in FIG. 11, the ride offer search server 100 may include a central processing unit (CPU) 91, a main memory 92 connected to the CPU 91 via a motherboard (M/B) chip set 93, and a display driver 94 connected to the CPU 91 via the same M/B chip set 93. A network interface 96, a magnetic disk device 97, an audio driver 98, and a keyboard/mouse 99 are also connected to the M/B chip set 93 via a bridge circuit 95.

In FIG. 11, the various configurational elements are connected via buses. For example, the CPU 91 and the M/B chip set 93, and the M/B chip set 93 and the main memory 92 are connected via CPU buses, respectively. Also, the M/B chip set 93 and the display driver 94 may be connected via an accelerated graphics port (AGP). However, when the display driver 94 includes a PCI express-compatible video card, the M/B chip set 93 and the video card are connected via a PCI express (PCIe) bus. Also, when the network interface 96 is connected to the bridge circuit 95, a PCI Express may be used for the connection, for example. For connecting the magnetic disk device 97 to the bridge circuit 95, a serial AT attachment (ATA), a parallel-transmission ATA, or peripheral components interconnect (PCI) may be used. For connecting the keyboard/mouse 99 to the bridge circuit 95, a universal serial bus (USB) may be used.

In the above explanation, the transfer route includes two routes, one passing near the origin and one passing near the destination. However, the number of the routes in a single transfer route is not limited to two. For example, a single transfer route may include three or more routes. That is to say, the passenger may change the vehicles two times or more in the single transfer route.

In the above explanation, the transfer route includes two routes, and both of the two routes cross the efficient route. However, the transfer route may include a route not crossing the efficient route.

In the above explanation, the adjacent meshes surrounds the origin (destination) mesh. However, the adjacent meshes are not required to surround the origin (destination) mesh. For example, if the origin of the passenger's travel is located on the edge of the area the ride offer search server 100 covers, the adjacent meshes do not surround the origin mesh.

In the above explanation, the preference is specified as to the get-on point and the get-off point. The ride offer search server 100 may further receive the preference as to transfer points. For example, the transfer route is assumed to include two routes, i.e., the first route and the second route. The passenger may specify the preference as to the get-off point on the first route, and as to the get-on point on the second route. In this example, the candidate points for transfer may be narrowed down by searching the context index using the preference as to the transfer points. Note that the preference may be specified as to at least one of the get-on point, the get-off point and the transfer points.

In the above explanation, the area in the map is divided into the meshes. However, the shape of the divided area is not limited to the mesh, i.e., the square or rectangular shape. Further, the area may be divided by streets or region classification, such as administrative districts.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for searching for a ride offer, comprising:
receiving a plurality of ride offers, wherein each of the plurality of ride offers specifies a route that a vehicle passes along;
receiving location information of an origin and a destination for a passenger, and a preference of the passenger for at least one of a get-on point, where the passenger gets into the vehicle, and a get-off point, where the passenger gets out of the vehicle;
determining an origin candidate point being a point in a first predetermined range from the origin, wherein the origin candidate point satisfies the preference for the get-on point;
determining an origin route being one of the routes specified in the received plurality of ride offers, wherein the origin route passes through the origin candidate point;
determining a destination candidate point being a point in a second predetermined range from the destination, wherein the destination candidate point satisfies the preference for the get-off point;
determining a destination route being one of the routes specified in the received plurality of ride offers, wherein the destination route passes through the destination candidate point; and
determining an optimum route to suggest to the passenger, wherein the optimum route includes both the origin route and the destination route in common.

2. The computer-implemented method according to claim 1, wherein the first predetermined range from the origin includes an origin area covering the origin and an adjacent area that is adjacent to the origin area.

3. The computer-implemented method according to claim 2, wherein the origin area and the adjacent area have a substantially square or rectangular shape.

4. The computer-implemented method according to claim 2, wherein the origin candidate point is within a predetermined distance from the origin.

5. The computer-implemented method according to claim 1, further comprising:
storing a preference relationship between one or more divided areas and one or more passing points as to the preference, wherein the one or more divided areas are divisions of an area covering the origin, and wherein the one or more passing points are included in at least one of the one or more divided areas, the one or more passing points satisfying the preference;
selecting the first predetermined range from the origin and from the one or more divided areas; and
identifying the one or more passing points included in the selected first predetermined range from the origin, based on the stored preference relationship.

6. The computer-implemented method according to claim 5, further comprising:
storing a route relationship between the one or more passing points and the route as to the preference, wherein the route passes through at least one of the one or more passing points; and
selecting the origin route from the route based on the stored route relationship.

7. The computer-implemented method according to claim 1, further comprising displaying an image on an output terminal operated by the passenger to receive the preference from the passenger.

8. The computer-implemented method according to claim 1, further comprising determining a second optimum route to suggest to the passenger if the optimum route is not found, wherein the second optimum route is a combination of the origin route and the destination route.

9. The computer-implemented method according to claim 8, wherein the origin route and the destination route in the second optimum route have no intersection with each other.

10. The computer-implemented method according to claim 1, further comprising:
receiving the location information for the origin and the destination of the passenger;
determining a connecting route, wherein the connecting route connects the origin and the destination; and wherein
the origin route includes a first section within the first predetermined range from the origin and crosses the connecting route;
the destination route includes a second section within the second predetermined range from the destination and crosses the connecting route; and
the optimum route is a combination of the origin route and the destination route.

11. The computer-implemented method according to claim 10, further comprising:
determining the optimum route based on an origin-oriented manner and a destination-oriented manner, wherein the origin-oriented manner focuses on the origin route crossing the connecting route, and the destination-oriented manner focuses on the destination route crossing the connecting route.

12. The computer-implemented method according to claim 10, wherein the connecting route comprises a plurality of sub-routes, wherein each of the plurality of sub-routes connects the origin and the destination, and wherein each of the plurality of sub-routes have a predetermined relationship with a shortest route among the plurality of sub-routes.

13. The computer-implemented method according to claim 12, wherein each of the plurality of sub-routes is assigned a priority based on a length of each of the plurality of sub-routes, and the combination of the origin route and the destination route is determined based on the priority of each of the plurality of sub-routes that the origin route crosses, and the priority of each of the plurality of sub-routes that the destination route crosses.

14. The computer-implemented method according to claim 10, wherein the optimum route is determined based on a first length of a first path between the origin and the origin route, and a second length of a second path between the destination and the destination route.

15. The computer-implemented method according to claim 10, wherein the optimum route is determined based on a length of a shortest path between the origin route and the destination route.

16. The computer-implemented method according to claim 10, further comprising:
receiving the preference of the passenger for at least one of the get-on point, wherein the passenger gets into the vehicle, and the get-off point, wherein the passenger gets out of the vehicle; and
determining the optimum route based on the preference for the get-on point and the get-off point.

17. The computer-implemented method according to claim 10, further comprising:
receiving the preference of the passenger for the get-off point, where the passenger gets out of the vehicle on the origin route, and for the get-on point, where the passenger gets into the vehicle on the destination route; and
determining the optimum route based on the preference for the get-off point and the get-on point.

18. A ride offer search apparatus comprising:
a ride offer receiver that receives a plurality of ride offers, wherein each ride offer, of the plurality of ride offers, specifies a route that a vehicle passes along;
a preference receiver that receives location information for an origin and a destination of a passenger, and a preference of the passenger for at least one of a get-on point, where the passenger gets into the vehicle, and a get-off point, where the passenger gets out of the vehicle;
an origin candidate point determinator that determines an origin candidate point, wherein the origin candidate point is a point in a first predetermined range from the origin, and satisfies the preference for the get-on point;
an origin route determinator that determines an origin route, wherein the origin route is one of the routes specified in the plurality of ride offers, and passes through the origin candidate point;
a destination candidate point determinator that determines a destination candidate point, wherein the destination candidate point is a point in a second predetermined range from the destination, and satisfies the preference for the get-off point;
a destination route determinator that determines a destination route, wherein the destination route is one of the routes specified in the plurality of ride offers and passes through the destination candidate point; and
an optimum route determinator that determines an optimum route to suggest to the passenger, wherein the optimum route includes both the origin route and the destination route in common.

19. The ride offer search apparatus of claim 18, further comprising:
a location receiver that receives the location information for the origin and the destination of the passenger;
a connecting route determinator that determines a connecting route, wherein the connecting route connects the origin and the destination; and wherein
the origin route includes a first section within the first predetermined range from the origin and crosses the connecting route;
the destination route includes a second section within the second predetermined range from the destination and crosses the connecting route; and
the optimum route is a combination of the origin route and the destination route.

20. A computer program product for searching for a ride offer, the computer program product comprising a computer readable storage medium having program instructions embodied therewith, the program instructions executable by a computer to cause the computer to:
receive a plurality of ride offers, wherein each of the plurality of ride offers specifies a route that a vehicle passes along;
receive location information of an origin and a destination for a passenger, and a preference of the passenger for at least one of a get-on point, where the passenger gets into the vehicle, and a get-off point, where the passenger gets out of the vehicle;
determine an origin candidate point being a point in a first predetermined range from the origin, wherein the origin candidate point satisfies the preference for the get-on point;
determine an origin route being one of the routes specified in the plurality of ride offers, wherein the origin route passes through the origin candidate point;
determine a destination candidate point being a point in a second predetermined range from the destination, wherein the destination candidate point satisfies the preference for the get-off point;
determine a destination route being one of the routes specified in the received plurality of ride offers, wherein the destination route passes through the destination candidate point; and
determine an optimum route to suggest to the passenger, wherein the optimum route includes both the origin route and the destination route in common.
